(19) United States
(12) Patent Application Publication
(10) Pub. No.: US 2010/0319405 A1
(43) Pub. Date: Dec. 23, 2010

(54) OPTICAL FIBER MANUFACTURING DEVICE AND OPTICAL FIBER MANUFACTURING METHOD

(75) Inventor: Kenji Okada, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: Fujikura Ltd., Kohtoh-ku, Tokyo (JP)

(21) Appl. No.: 12/444,808

(22) PCT Filed: Dec. 24, 2008
(86) PCT No.: PCT/JP2008/073456

§ 371 Date: Apr. 8, 2009

(30) Foreign Application Priority Data
Oct. 31, 2008 (JP) 2008-282506

(51) Int. Cl. C03C 25/10; C03B 37/02

(52) U.S. Cl. 65/430; 65/529

(57) ABSTRACT

An optical fiber manufacturing device includes a bare optical fiber-forming unit that forms a bare optical fiber by pulling an optical fiber preform; a coating unit that forms an optical fiber by coating the bare optical fiber outputted from the bare optical fiber-forming unit with a coating layer; a first direction-converter, which is a solid body that comes into contact with the optical fiber outputted from the coating unit and thereby first changing its traveling direction; and a winder that winds the optical fiber obtained from the first direction-converter, in which: the first direction-converter is a rotating body having a circumferential face that contacts with the optical fiber and is formed around an axis of rotation thereof; and the contact angle, centered on the axis of rotation, between this rotating body and the optical fiber is in the range of 10° to 80°.

The present Application claims priority from Japanese Patent Application No. 2008-282506, filed Oct. 31, 2008, the content of which is incorporated herein by reference.

### TECHNICAL FIELD

Apparatuses and methods consistent with the present invention relate to an optical fiber manufacturing device and an optical fiber manufacturing method that manufacture an optical fiber by drawing an optical fiber from an optical fiber preform.

### BACKGROUND

Generally, optical fiber drawing is performed with an optical fiber manufacturing device (not shown) by steps such as the following.

Firstly, an optical fiber preform is inserted into a heating furnace, and a front end of the optical fiber preform is heat-melted at a temperature of approximately 2000° C. to form a bare optical fiber, which is removed from the heating furnace. The removed bare optical fiber is then cooled to a temperature at which it can be coated. In a coating unit of the optical fiber manufacturing device, the cooled bare optical fiber is coated with resin such as heat-curable resin or ultraviolet-curable resin, and the resin is cured by heating or ultraviolet rays to form a coating layer for protecting the surface of the bare optical fiber; thus an optical fiber is obtained. The coating layer generally has a two-layer structure that includes an inner layer made of a material having a low Young's modulus, and an outer layer made of a material having a high Young's modulus. In the optical fiber manufacturing device, after a pulley changes the traveling direction of the optical fiber outputted from this coating unit, the optical fiber is wound in a winder.

In the step of coating the bare optical fiber in the drawing steps mentioned above, it is important that the axis of the coating layer is coaxial with the axis of the bare optical fiber. If the coating layer is eccentric with respect to the bare optical fiber, there is a possibility that the optical fiber will bend, or that its side-pressure characteristics will deteriorate. In particular, when the amount of eccentricity is extremely large, there is a possibility that the bare optical fiber will be damaged by contact with the inner wall and the like of the coating unit, reducing the strength of the optical fiber.

Conceivable causes of the coating layer being eccentric to the bare optical fiber include uneven flow of resin in the dice land of the coating unit, asymmetry of the dice land itself, and the like. As countermeasures against this, for example, Japanese unexamined Patent Application, First Publication No. 2003-252653 (JP 2003-252653) discloses an optical fiber forming device including a coating layer irregularity-detector for detecting irregularities in the coating layer of the optical fiber, and a coating unit that can coat the bare optical fiber while being tilted with respect to a plane that is perpendicular to the direction in which the bare optical fiber passes through the coating unit; the device controls the tilt angle of the coating unit in accordance with irregularities detected by the coating layer irregularity-detector, and coats the bare optical fiber such as to minimize the output of irregularities.

### SUMMARY OF THE INVENTION

As described above, in the technology of JP 2003-252653, the coating unit is tilted with respect to the bare optical fiber when forming an optical fiber. Therefore, even if the amount of eccentricity of the coating layer to the bare optical fiber is successfully reduced, the tilt of the coating unit increases a possibility that the bare optical fiber will contact with components of the coating unit other than the dice (for example, a nipple, and a purge component for preventing intrusion of bubbles into the coating layer that is provided in a top part of the coating unit). If the bare optical fiber makes contact with these components, there is a possibility that it will be damaged and its strength will deteriorate. If the inner coating layer of the optical fiber makes contact, there is a possibility that the surface of the inner coating layer will be scratched, roughing the interface with the outer coating layer, marring an external appearance of the optical fiber, and increasing loss due to microbending. Moreover, if an attempt is made to prevent such contact by increasing the hole diameter of the nipple or increasing the hole diameter of the purge component, there is a possibility that the coating resin will spill out from the top part of the nipple, or that purge gas will escape, reducing the effectiveness of bubble-intrusion prevention.

As shown by the broken line in FIG. 11, a bare optical fiber Fa and an optical fiber Fb, which travel between a heating furnace 101 and a pulley (not shown) provided on the lower side than the heating furnace 101 in the vertical direction, preferably extend vertically downwards in a straight line. In this case, since the bare optical fiber Fa can pass through a central position of a coating unit 102 without deviating, the eccentricity of the coating layer with respect to the bare optical fiber Fa can be suppressed. In FIG. 11, reference numeral 103 represents a cooler, reference numeral 104 represents a resin-curing unit, and reference letter M represents an optical fiber preform.

However, to increase productivity, there is a recent demand for higher drawing speeds. Tests conducted by the present inventors revealed that, with the configuration of the optical fiber forming device disclosed in JP 2003-252653, when the drawing speed is increased to 1500 meters/minute (m/min) or more, elements such as centrifugal force and rigidity of the optical fiber Fb result in a bending of the bare optical fiber Fa and the optical fiber Fb traveling between the heating furnace 101 and the pulley, as shown by the dashed double-dotted line in FIG. 11. That is, when the drawing speed is high at 1500 m/min or more, the fluctuation of the actual path-line of the optical fiber (double-dashed dotted line) with respect to an ideal path-line (broken line) increases in accordance with the increase in the drawing speed.

In the case illustrated by the double-dashed dotted line, since the path-line of the bare optical fiber Fa as it passes through the coating unit fluctuates greatly with respect to the coating unit 102, the eccentricity of the coating layer to the bare optical fiber Fa cannot be suppressed sufficiently just by tilting the coating unit 102. Consequently, it is necessary that, in accordance with the degree of bending, the coating unit 102 be moved in the horizontal direction to ensure that the bare optical fiber Fa passes through the central position of the coating unit 102. Further, when the actual path-line of the bare optical fiber Fa fluctuates greatly with respect to the ideal path-line, the cooler 103 and the resin-curing unit 104, provided at the front and rear of the coating unit 102, respectively, must also be moved to prevent them from contacting the bare optical fiber Fa and the optical fiber Fb. When mechanisms (not shown) for moving the cooler 103 and the resin-curing unit 104 in accordance with the increase in drawing speed are provided, the scale of the optical fiber manufacturing device is greatly increased.

Exemplary embodiments of the present invention were devised in view of the above circumstances, and have, as an exemplary object, the provision of an optical fiber manufacturing device and an optical fiber manufacturing method that, with a simple configuration, can manufacture a high-quality optical fiber, even at a high drawing speed of 1500 m/min or more.

An optical fiber manufacturing device of an exemplary embodiment includes: a bare optical fiber-forming unit that forms a bare optical fiber by pulling an optical fiber preform; a coating unit that forms an optical fiber by coating the bare optical fiber outputted from the bare optical fiber-forming unit with a coating layer; a first direction-converter, which is a solid body that comes into contact with the optical fiber outputted from the coating unit and thereby changing its traveling direction; and a winder that winds the optical fiber obtained from the first direction-converter, in which: the first direction-converter is a rotating body having a circumferential face that contacts with the optical fiber and is formed around an axis of rotation of the rotating body; and a contact angle, centered on the axis of rotation, between this rotating body and the optical fiber is in the range of 10° to 80°.

According to the optical fiber manufacturing device, the bare optical fiber-forming unit forms a bare optical fiber by pulling an optical fiber preform. Then, the coating unit forms an optical fiber by coating the bare optical fiber outputted from the bare optical fiber-forming unit with a coating layer. The first direction-converter changes the traveling direction of the optical fiber outputted from the coating unit, and the optical fiber is wound in the winder. During this series of processes, a contact angle between the rotating body constituting the first direction-converter and the optical fiber is maintained in the range of 10° to 80°.

According to this exemplary embodiment, eccentricity may be reduced without tilting the coating unit in the conventional manner, thereby reducing the possibility that the optical fiber will contact the coating unit. Since this avoids any increase in poor strength and poor external appearance of the optical fiber and in loss due to microbending, it becomes possible to manufacture a high-quality optical fiber.

Moreover, according to the optical fiber manufacturing device, since eccentricity can be reduced without tilting or moving the coating unit, there is no need for a tilting mechanism or a moving mechanism, enabling the device configuration to be simplified.

The circumferential face, when viewed in a cross-section including the axis of rotation, may be a flat shape with a predetermined width.

Since this enables the optical fiber to move freely along the width direction of the circumferential face of the first direction-converter, one-directional twisting of the optical fiber and increased eccentricity can be more reliably prevented.

A second rotating body that constitutes a second direction-converter for further changing the traveling direction of the optical fiber may be provided between the rotating body and the winder.

This second direction-converter can change the traveling direction of the optical fiber to a desired direction.

The absolute position of the axis of rotation of the other rotating body may be fixed.

In this case, even if the optical fiber moves freely along the width direction of the circumferential face of the first direction-converter, wobbling of the optical fiber is suppressed and its path-line is stabilized. As a result, an optical fiber having low eccentricity and low fluctuation of eccentricity in the longitudinal direction can be manufactured.

The rotating body constituting the first direction-converter and the other rotating body constituting the second direction-converter may rotate in mutually opposite directions.

In this case, centrifugal forces acting on the optical fiber at the first direction-converter and the second direction-converter work in mutually opposite directions, and the forces acting on the optical fiber thus cancel each other. Therefore, deviation of the optical fiber from its desired path-line can be more reliably suppressed.

An optical fiber manufacturing method according to an exemplary embodiment of the invention includes: a bare optical fiber-formation step of forming a bare optical fiber by pulling an optical fiber preform; a coating step of forming an optical fiber by coating the bare optical fiber obtained after the bare optical fiber-formation step with a coating layer; a first direction-conversion step of making a circumferential face of a rotating body, which is a solid body for first changing the traveling direction of the optical fiber obtained after the coating step, contact with the optical fiber, and thereby changing the traveling direction of the optical fiber; and a winding step of winding the optical fiber obtained after the first direction-conversion step; in which, in the first direction-conversion step, the contact angle, centered on an axis of rotation of the rotating body, between the rotating body and the optical fiber is in the range of 10° to 80°.

In the exemplary optical fiber manufacturing method described above, in the first direction-conversion step, the contact angle between the rotating body, which is the first solid body that changes the traveling direction of the optical fiber, and the optical fiber is set in the range of 10° to 80°.

According to this exemplary embodiment, in the coating step, eccentricity may be reduced without tilting the coating unit in the conventional manner, thereby reducing the possibility that the optical fiber will contact with the coating unit. Since this avoids any increase in poor strength and poor external appearance of the optical fiber and in loss due to microbending, it becomes possible to manufacture a high-quality optical fiber.

Further, according to this optical fiber manufacturing method, in the coating step, since eccentricity can be reduced without tilting or moving the coating unit, there is no need for a tilting mechanism or a moving mechanism, enabling the device configuration to be simplified.

In the first direction-conversion step, when the circumferential face is viewed in a cross-section including the axis of rotation, the optical fiber may be allowed to move freely in the width direction of the circumferential face.

This configuration can more reliably prevent one-directional twisting of the optical fiber and increase in eccentricity.

A second direction-conversion step of further changing the traveling direction of the optical fiber by making it contact with another rotating body, which is provided downstream from the rotating body, may be provided between the first direction-conversion step and winding step.

In this case, in the second direction-conversion step, the traveling direction of the optical fiber can be changed to a desired direction.

The absolute position of the axis of rotation of the other rotating body may be fixed.

In this case, even if the optical fiber moves freely along the width direction of the circumferential face in the first direction-converter step, wobbling of the optical fiber is suppressed and its path-line is stabilized. As a result, an optical fiber having low eccentricity and low fluctuation of eccentricity in the longitudinal direction can be manufactured.

The direction of the change in the traveling direction of the optical fiber in the first direction-conversion step, and the direction of the change in the traveling direction of the optical fiber in the second direction-conversion step, may be mutually opposite directions.

In this case, centrifugal forces acting on the optical fiber during the first direction-conversion step and the second direction-conversion step work in mutually opposite directions, and the forces acting on the optical fiber thus cancel each other. Therefore, deviation of the optical fiber from its desired path-line can be more reliably suppressed.

A minimum drawing speed of the bare optical fiber may be 1500 m/min.

According to an exemplary embodiment, an optical fiber traveling between a coating unit and a rotating body can be made to follow a desired path-line. Thus, even if the drawing speed is high at 1500 m/min or more, the path-line of a bare optical fiber as it passes the coating unit can be prevented from greatly fluctuating with respect to the coating unit, thereby suppressing eccentricity of the coating layer with respect to the bare optical fiber. Therefore, a high-quality optical fiber can be manufactured at a high drawing speed and with a simple configuration.

Further, an optical fiber manufacturing method of an exemplary embodiment can achieve similar effects to those of the optical fiber manufacturing device.

### BRIEF DESCRIPTION OF THE DRAWINGS

FIG. 1 is an explanatory view of an optical fiber manufacturing device according to a first exemplary embodiment of the invention.

FIG. 2 is a plan view of an exemplary pulley of an optical fiber manufacturing device.

FIG. 3 is a graph of exemplary measurements of the relationship between a contact angle θ of an optical fiber with a pulley, and the thickness variation of the optical fiber, the horizontal axis representing contact angle (°) and the vertical axis representing the level of thickness variation.

FIG. 4 is an explanatory view of a definition of thickness variation, being a cross-sectional view of an optical fiber when seen in cross-section perpendicular to the longitudinal direction of the fiber.

FIG. 5 is an enlarged view of portion A of FIG. 1.

FIG. 6 is an enlarged view of portion A of FIG. 1, and illustrates a path-line of the optical fiber when the contact angle θ is less than 10°.

FIG. 7 is an explanatory view of an optical fiber manufacturing device according to a second exemplary embodiment of the invention.

FIG. 8 is an explanatory view of an optical fiber manufacturing device according to a third exemplary embodiment of the invention.

FIG. 9 is an explanatory view of an optical fiber manufacturing device according to a fourth exemplary embodiment of the invention.

FIG. 10 is an explanatory view of an optical fiber manufacturing device according to a fifth exemplary embodiment of the invention.

FIG. 11 is an explanatory view of a related art optical fiber manufacturing device.

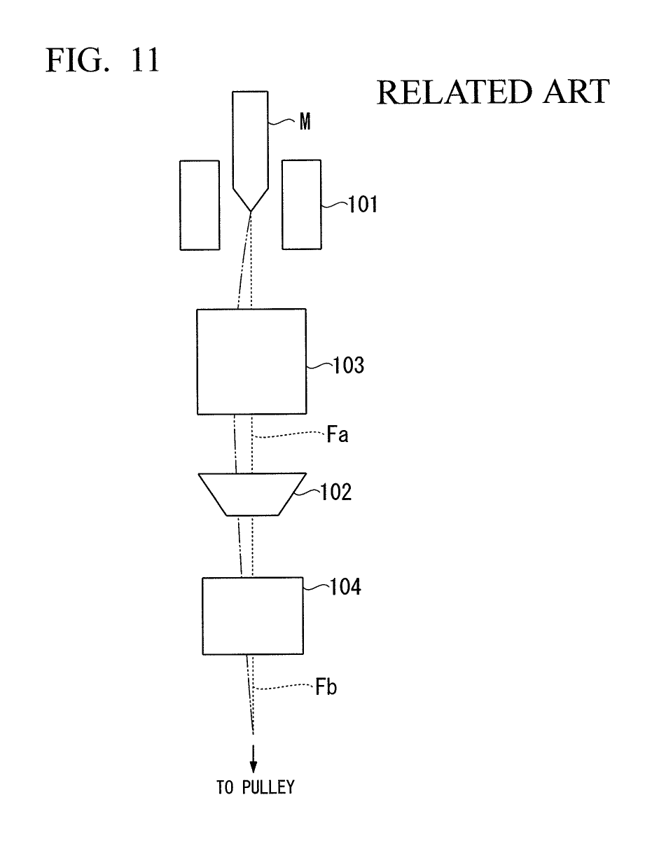

### DETAILED DESCRIPTION OF EXEMPLARY EMBODIMENTS OF THE INVENTION

### First Exemplary Embodiment

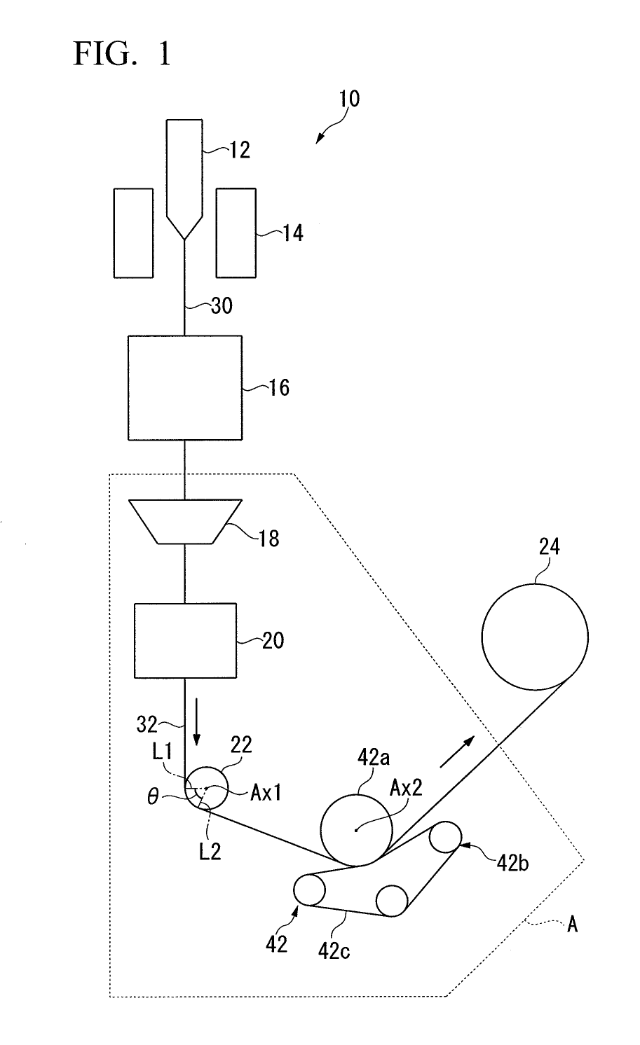

FIG. 1 is an explanatory view of an optical fiber manufacturing device 10 according to a first exemplary embodiment of the invention. The optical fiber manufacturing device 10 includes a heating furnace 14 (bare optical fiber-forming unit), a cooler 16, a coating unit 18, a resin-curing unit 20, a pulley 22 (first direction-converter), a capstan 42, and a winder 24. The heating furnace 14 is arranged at the topmost part, the cooler 16 is arranged immediately and coaxially below (downstream from) the heating furnace 14, and the coating unit 18 and the resin-curing unit 20 are provided immediately below (downstream from) the cooler 16, being arranged substantially coaxially in that sequence.

In an optical fiber drawing step using the optical fiber manufacturing device 10, an optical fiber preform 12 is heat-melted in the heating furnace 14 at a temperature of approximately 2000° C., and a bare optical fiber 30 is drawn out while ensuring that its outer diameter is constant. This bare optical fiber 30 is then cooled to approximately 100° C. in the cooler 16.

Next, the bare optical fiber 30 is passed through the coating unit 18, where it is coated with an ultraviolet-curable resin or a heat-curable resin to form a coating layer. Then, the resin is cured with a resin-curing unit 20 such as an ultraviolet irradiation furnace or a heating furnace, obtaining an optical fiber 32. The pulley 22 changes the traveling direction of the optical fiber 32 thus obtained (to the bottom right, as shown in FIG. 1), the capstan 42 changes the traveling direction a second time (to the top right, as shown in FIG. 1), and the optical fiber 32 is then wound in the winder 24.

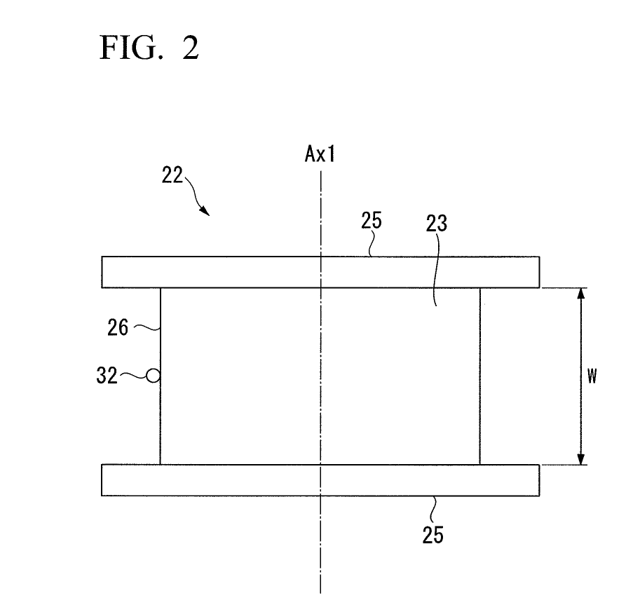

FIG. 2 is a plan view of the pulley 22. In this embodiment, the pulley 22 has a flat groove structure having a flat groove with a width of W. The pulley 22 includes a cylindrical pulley main-body 23, and a pair of flange units 25 provided at both ends in the axial direction of the pulley main-body 23. The pulley 22 is arranged such that it can rotate with the central axis of the pulley main-body 23 as its axis of rotation Ax1. The pulley main-body 23 has an outer peripheral face 26 (circumferential face) which is formed around the axis of rotation Ax1 and contacts with the optical fiber 32. A part of this outer peripheral face 26 serves as a contact face with which the optical fiber 32 makes contact. The pulley 22 is arranged such that its axis of rotation Ax1 and the traveling direction of the optical fiber 32 are skew (in other words, such that they are mutually perpendicular when seen in the perspective view of FIG. 2). The width W of the outer peripheral face 26 of the pulley 22 is approximately 10 mm, this being extremely large in comparison with the outer diameter of the optical fiber 32, which is approximately 250 μm. When viewed in a cross-section, including the axis of rotation Ax1, the outer peripheral face 26 is flat, with no unevenness that would obstruct the movement of the optical fiber 32 on it.

The capstan 42 extracts the optical fiber 32 at a predetermined drawing speed and tensile force such that the outer diameter of the optical fiber 32 remains constant. The capstan 42 includes a rotating body 42a, a belt 42c, and a rotating body 42b that rotates accompanying with the belt 42c, and pulls the optical fiber 32 between the rotating body 42a and the belt 42c. Here, the position of the axis of rotation Ax2 of the rotating body 42a is fixed.

In the optical fiber manufacturing device 10 according to this embodiment, to reduce the eccentricity of the coating layer with respect to the bare optical fiber 30 (hereinafter simply referred to as “eccentricity”), the contact angle θ between the optical fiber 32 and the pulley 22, which is the first solid body that changes the traveling direction of the optical fiber 32 after it has been extracted from the resin-curing unit 20, is in the range of about 10° to 80°. Here, the contact angle θ between the optical fiber 32 and the pulley 22 is the angle formed by line L1 that joins a point where the optical fiber 32 and the pulley 22 begin to make contact to the axis of rotation Ax1 of the pulley 22, and line L2 that joins a point where the optical fiber 32 begins to separate from the pulley 22 to the axis of rotation Ax1 of the pulley 22.

The inventors conducted detailed research into eccentricity-reduction. As a result of this research it was found that, rather than an uneven flow of resin in the dice land and asymmetry of the dice land itself, which are conventionally believed to cause eccentricity, a greater cause of eccentricity is bending of the optical fiber due to centrifugal forces generated by the optical fiber's own weight, rigidity of the optical fiber, and the like, whereby the path-line of the bare optical fiber as it passes the coating unit fluctuates greatly with respect to the coating unit. The inventors also found that the contact angle θ between the optical fiber 32 and the first pulley 22 that changes the traveling direction of the optical fiber 32 is relevant to this problem. Accordingly, the inventors measured changes in eccentricity of the coating layer when the contact angle θ was changed.

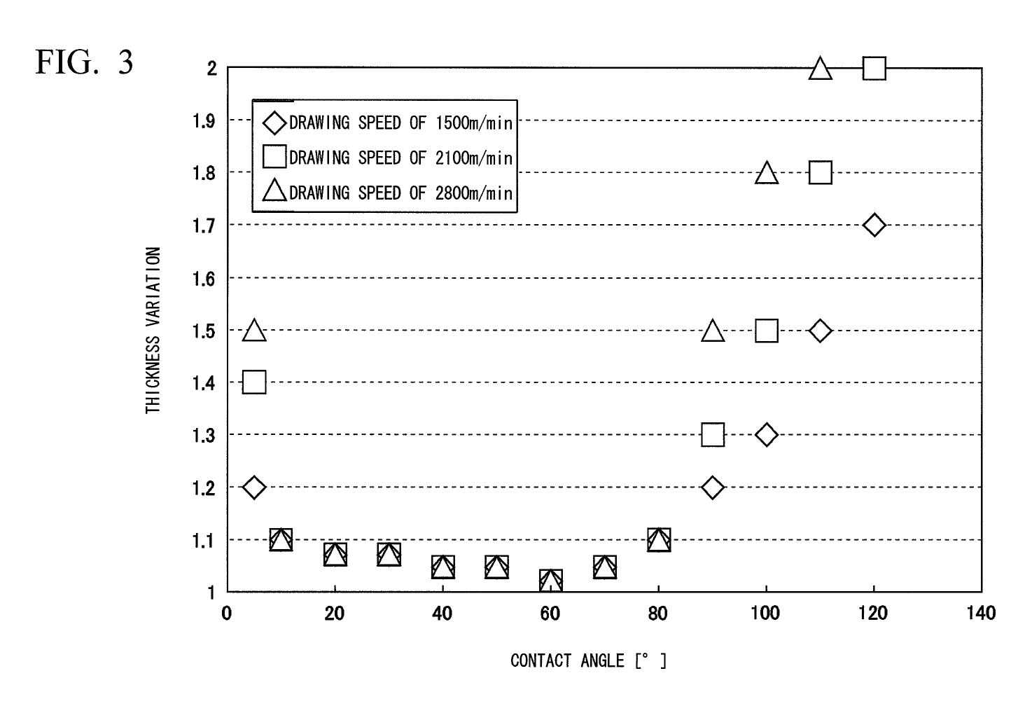

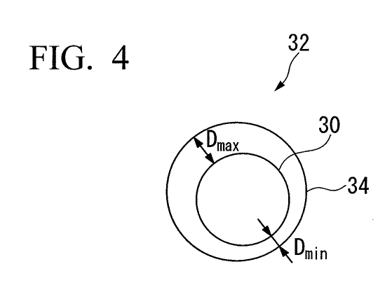

FIG. 3 is a graph of measurements of the relationship between the contact angle θ and the thickness variation of an optical fiber. In FIG. 3, the horizontal axis represents the contact angle θ (°), and the vertical axis represents the level of thickness variation. FIG. 4 is a cross-sectional view for explaining a definition of thickness variation. In this application, thickness variation is used as an indicator of the eccentricity of the coating layer with respect to the bare optical fiber.

As shown in FIG. 4, the optical fiber 32 is configured such that a coating layer 34 coats the outside surface of the bare optical fiber 30. As shown in FIG. 4, when Dmax is the maximum thickness of the coating layer 34 across a cross-section of the optical fiber 32 and Dmin is the minimum thickness, the thickness variation is expressed as Dmax/Dmin. For example, when the bare optical fiber 30 and the coating layer 34 are concentric, Dmax=Dmin, and the thickness variation=1; thus, the closer the thickness variation is to 1, the better the quality of the product.

As shown in FIG. 3, the inventors measured the relationship between the contact angle θ and thickness variation at drawing speeds of 1500, 2100, and 2800 m/min. At each of these drawing speeds of 1500, 2100, and 2800 m/min, it was confirmed that, when the contact angle θ between the optical fiber 32 and the pulley 22, which is the first solid body that changes the traveling direction of the optical fiber 32, is set in the range of 10° to 80°, the thickness variation can be reduced to a remarkably small value of 1.1 or less.

When the contact angle θ is set in the range of 10° to 80°, there is less bending of the bare optical fiber 30 and the optical fiber 32 that travel between the heating furnace 14 and the pulley 22, and so there is less fluctuation of the actual path-line of the optical fiber with respect to the ideal path-line. Since this makes it possible to prevent the path-line of the bare optical fiber 30 from greatly fluctuating with respect to the coating unit 18 as it passes through the coating unit 18, the thickness variation of the coating layer during coating can be reduced to a remarkably small value.

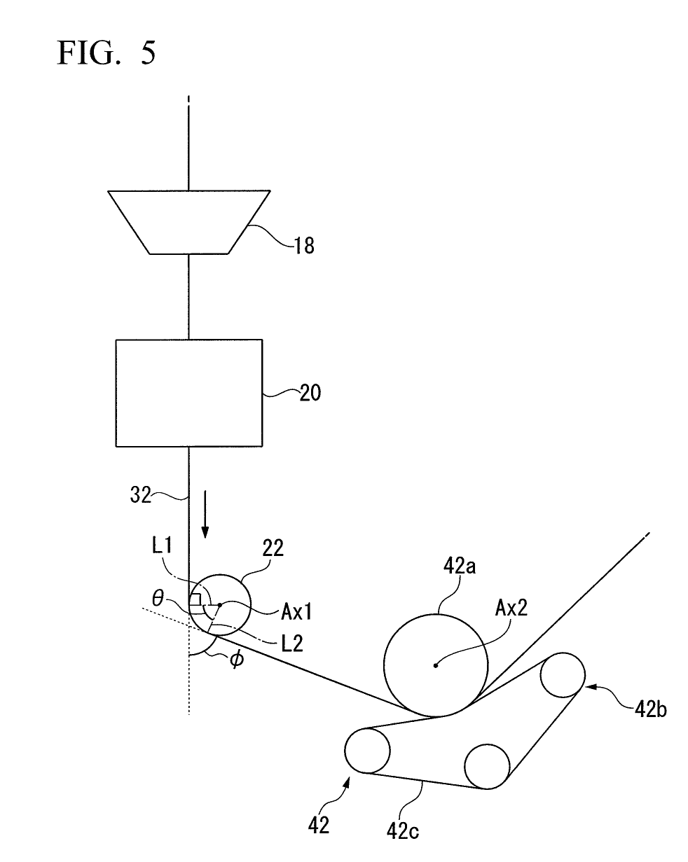

In this embodiment, as shown in FIG. 5, a change angle y of the traveling direction of the optical fiber 32 made by the pulley 22 is approximately the same as the contact angle θ. Further, the angle between the optical fiber 32 and a straight line that passes the axis of rotation Ax1 and extends along the horizontal direction (line L1) is approximately a right-angle. Therefore, the path-lines of the bare optical fiber 30 and the optical fiber 32 traveling between the heating furnace 14 and the pulley 22 approximately match the ideal path-line extending vertically in a straight line.

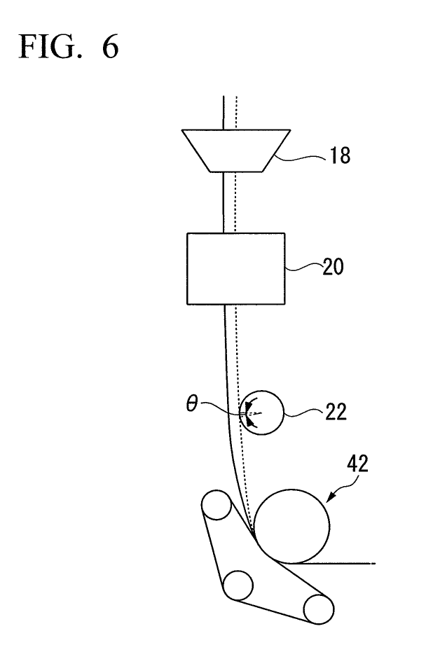

When the contact angle θ is less than 10°, there is not enough contact between the pulley 22 and the optical fiber 32, and consequently not enough friction between them, leading to a possibility that the optical fiber 32 will slide over the pulley 22. Also, when the contact angle θ is less than 10°, as shown in FIG. 6, there is a possibility that the optical fiber 32 will bend and not make contact with the pulley 22, whereby the capstan 42 will serves as a first solid body that first changes the traveling direction of the optical fiber 32. In this case, the fluctuation of the actual path-line (solid line) of the optical fiber 32 with respect to its ideal path-line (broken line) increases. Thus, when the contact angle θ is less than 10°, the pulley 22 is less able to affect control of the path-line of the optical fiber 32, reducing the effect of suppressing path-line fluctuation and increasing the thickness variation.

Furthermore, when the contact angle θ is greater than 80°, centrifugal force and the like acting on the optical fiber 32 makes it liable to deviate from the desired path-line as it travels between the coating unit 18 and the pulley 22, consequently increasing its path-line fluctuation and increasing its thickness variation.

Thus, in the optical fiber manufacturing device 10 according to this embodiment, by ensuring that the contact angle θ between the optical fiber 32 and the pulley 22 that first changes the traveling direction of the optical fiber 32 is in the range of 10° to 80°, it becomes possible to manufacture a high-quality optical fiber 32 with reduced thickness variation, even at a high drawing speed of 1500 m/min or more.

According to the optical fiber manufacturing device 10, since the thickness variation can be reduced without tilting the coating unit 18 as in the prior art, the possibility that the optical fiber 32 will contact the coating unit 18 can be reduced. This avoids any increase in poor strength and poor external appearance of the optical fiber, loss due to microbending, and such problems, and makes it possible to manufacture a high-quality optical fiber 32.

According to the optical fiber manufacturing device 10, it is possible to prevent large fluctuations of the path-line of the bare optical fiber 32 with respect to the coating unit 18 as it passes the coating unit 18. Therefore, the eccentricity of the coating layer can be reduced without attempting to compensate for path-line deviation by tilting the coating unit 18, and without moving the coating unit 18 and the cooler 16 horizontally. As a result, there is no need for a tilting mechanism, a moving mechanism, or the like, and the configuration of the optical fiber manufacturing device 10 can be simplified.

Also, in the optical fiber manufacturing device 10 according to this embodiment, the contact face of the pulley 22 with the optical fiber 32 is formed by a part of the outer peripheral face 26 of the cylindrical pulley main-body 23. Moreover, the width W of the outer peripheral face 26 of the pulley main-body 23 is approximately 10 mm, much larger than the outer diameter of the optical fiber 32, which is approximately 250 μm. Since the fluctuation of the actual path-line with respect to the ideal path-line is roughly a few millimeters, the position of the optical fiber 32 in the width direction of the outer peripheral face 26 is not substantially restricted. That is, the optical fiber 32 can move freely along the width direction of the outer peripheral face 26 of the pulley main-body 23.

For example, when the position of the optical fiber 32 in the width direction of the outer peripheral face 26 is restricted by providing a V-groove (not shown) in the outer peripheral face 26 in the circumferential direction, and aligning the optical fiber 32 with this V-groove, unless the V-groove is centered very precisely (to an order of several tens of μm), the optical fiber 32 will nonuniformly contact only one of the sloping faces that constitute the V-groove. When the optical fiber 32 is forcibly displaced by the V-groove in this manner, a force attempting to work in the ideal path-line acts on the optical fiber 32, with the result that the optical fiber 32 twists in one direction. Furthermore, if the optical fiber 32 is deviated from the center of a V-groove that is not ideally centered, the optical fiber 32 goes off-center, and the eccentricity of the coating layer increases. In contrast, in this embodiment, since the position of the optical fiber 32 is not substantially restricted in the width direction of the outer peripheral face 26, twisting of the optical fiber 32 and increased eccentricity of the coating layer can both be suppressed.

If the rotation axis of a rotating body that contacts the optical fiber 32 subsequent to the pulley 22 (a rotating body corresponding to the rotating body 42a) is not fixed (e.g., if it has an oscillating structure), when the center of the optical fiber 32 wobbles, in addition to the vibration of the optical fiber 32 in the lateral direction, there is also vibration (short-cycle line-speed fluctuation component) in the longitudinal direction, making it impossible to coat the optical fiber 32 stably. Therefore, in this case, unless this vibration is suppressed by providing a V-groove or the like in the outer peripheral face 26 of the pulley 22 provided on the upper side, eccentricity not only increases but also fluctuates along the longitudinal direction of the optical fiber 32. As already mentioned, however, formation of a V-groove leads to problems such as twisting of the optical fiber 32 and increased eccentricity of the coating layer.

On the other hand, in the optical fiber manufacturing device 10 according to this embodiment, the absolute position of the axis of rotation Ax2 of the rotating body 42a that contacts the optical fiber 32 subsequent to the pulley 22 is fixed. Consequently, even if the contact face of the pulley 22 with the optical fiber 32 is formed such that the position of the optical fiber 32 in the width direction of the outer peripheral face 26 is not restricted, wobbling of the optical fiber 32 is suppressed and the path-line is stabilized. As a result, it is possible to manufacture the optical fiber 32 having low eccentricity and low fluctuation of eccentricity in the longitudinal direction.

### Second Exemplary Embodiment

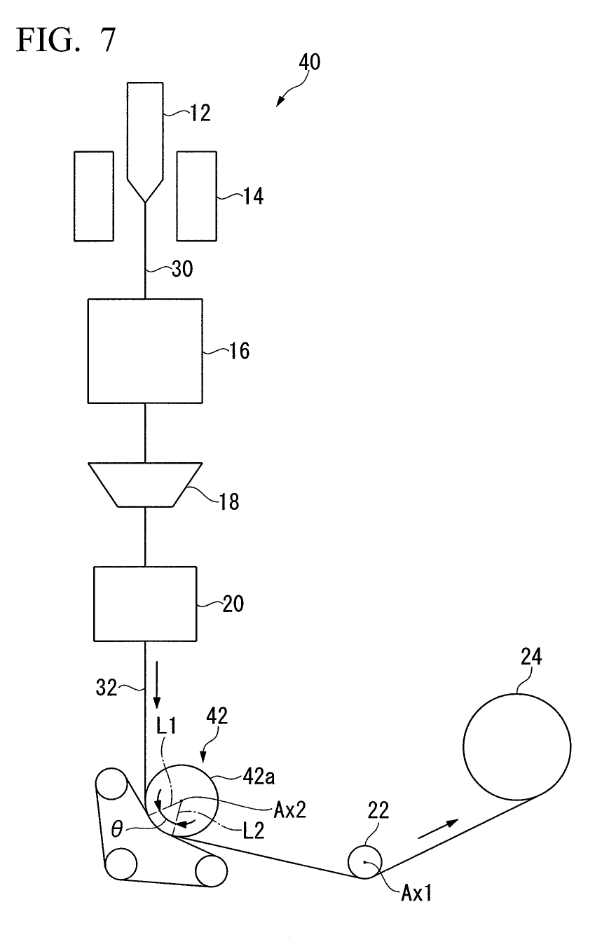

FIG. 7 is an explanatory view of an optical fiber manufacturing device 40 according to a second exemplary embodiment of the invention. Constituent elements of the optical fiber manufacturing device 40 shown in FIG. 7 that are identical to or correspondent with those of the optical fiber manufacturing device 10 shown in FIG. 1 are designated with identical reference numerals, and are not repetitiously explained.

In the optical fiber manufacturing device 40, an optical fiber 32 extracted from the resin-curing unit 20 is made to contact with the capstan 42 without first passing a pulley. The capstan 42 first changes the traveling direction of the optical fiber 32 in a direction, shown as toward the bottom right in FIG. 7, the pulley 22, having an axis of rotation Ax1 with a fixed position, changes the traveling direction again in a direction, shown as toward the top right in FIG. 7, and the optical fiber 32 is then wound in the winder 24. A rotating body 42a of the capstan 42 has a flat groove structure similar to that of the pulley 22 shown in FIG. 2, the width of the groove being approximately 10 mm.

In the optical fiber manufacturing device 40, by setting the contact angle θ between the optical fiber 32 and the rotating body 42a of the capstan 42, which is the first solid body that changes the traveling direction of the optical fiber 32 outputted from the resin-curing unit 20, in the range of 10° to 80°, a high-quality optical fiber 32 with reduced thickness variation can be manufactured, even at a high drawing speed of 1500 m/min or more.

As in the optical fiber manufacturing device 10 described above, the optical fiber manufacturing device 40 can avoid problems such as a decrease in strength, a poor external appearance of the optical fiber 32, and an increased loss due to microbending. Also, since there is no need for a tilting mechanism, a moving mechanism, or the like, the configuration of the optical fiber manufacturing device 40 can be simplified.

In this embodiment, the contact face of the rotating body 42a with the optical fiber 32 is formed such that it does not restrict the position of the optical fiber 32 in the width direction of the circumferential face of the rotating body 42a. Therefore, twisting of the optical fiber 32 and increase in the eccentricity of the coating layer are less likely to occur.

In this embodiment, the pulley 22, which is the solid body that contacts the optical fiber 32 subsequent to the rotating body 42a, is a rotating body, and the position of the axis of rotation Ax1 of this pulley 22 is fixed. Therefore, even if the contact face of the rotating body 42a with the optical fiber 32 is formed such that it does not restrict the position of the optical fiber 32 in the width direction of the circumferential face of the rotating body 42a, wobbling of the optical fiber 32 is suppressed and the path-line is stabilized. It is therefore possible to manufacture an optical fiber 32 having low eccentricity and low fluctuation of eccentricity in the longitudinal direction.

### Third Exemplary Embodiment

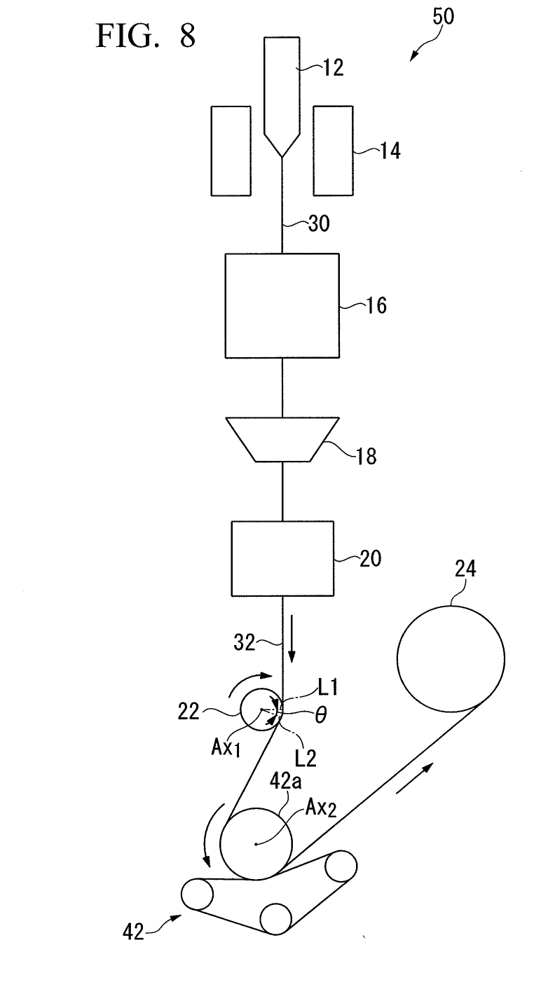

FIG. 8 is an explanatory view of an optical fiber manufacturing device 50 according to a third exemplary embodiment of the invention. Constituent elements of the optical fiber manufacturing device 50 shown in FIG. 8 which are identical to or correspondent with those of the optical fiber manufacturing device 10 shown in FIG. 1 are designated by identical reference numerals, and are not repetitiously explained.

In the optical fiber manufacturing device 50, a pulley 22, which first changes the traveling direction of an optical fiber 32 after it has been extracted from a resin-curing unit 20, and a rotating body 42a of a capstan 42 with which the optical fiber 32 subsequently contacts after passing the pulley 22, are arranged such that they rotate in mutually opposite directions as the optical fiber 32 passes. The structure of the pulley 22 is the same as that shown in FIG. 2. The position of the axis of rotation Ax2 of the rotating body 42a, which is the solid body with which the optical fiber 32 contacts subsequent to the pulley 22, is fixed.

In the optical fiber manufacturing device 50, by setting the contact angle θ between the optical fiber 32 and the pulley 22, which is the first solid body that changes the traveling direction of the optical fiber 32 outputted from the resin-curing unit 20, in the range of 10° to 80°, a high-quality optical fiber 32 with reduced thickness variation can be manufactured, even at a high drawing speed of 1500 m/min or more.

Moreover, since the pulley 22 and the rotating body 42a of the capstan 42 are arranged such that they rotate in mutually opposite directions as the optical fiber 32 passes, the centrifugal forces acting on the optical fiber 32 work in mutually opposite directions. Since the forces acting on the optical fiber 32 thus cancel each other, the path-line of the optical fiber 32 becomes less likely to fluctuate, and the optical fiber 32 can be manufactured with lower thickness variation.

As in the optical fiber manufacturing device 10 described above, the optical fiber manufacturing device 50 can avoid problems such as a decrease in strength, poor external appearance of the optical fiber 32, and increased loss due to microbending. Also, since there is no need for a tilting mechanism, a moving mechanism, or the like, the configuration of the optical fiber manufacturing device 50 can be simplified.

Also in this embodiment, the contact face of the pulley 22 with the optical fiber 32 is formed such that it does not restrict the position of the optical fiber 32 in the width direction of the outer peripheral face 26 of the pulley main-body 23 of the pulley 22. Therefore, one-directional twisting of the optical fiber 32 and increase in eccentricity are less likely to occur.

Further, in this embodiment, the rotating body 42a, which is the solid body that contacts the optical fiber 32 subsequent to the pulley 22, is a rotating body, and the position of the axis of rotation Ax2 of the rotating body 42a is fixed. Therefore, even if the contact face of the pulley 22 with the optical fiber 32 is formed such that it does not restrict the position of the optical fiber 32 in the width direction of the outer peripheral face 26 of the pulley main-body 23 of the pulley 22, wobbling of the optical fiber 32 is suppressed and the path-line is stabilized. Thus an optical fiber 32 having low eccentricity and low fluctuation of eccentricity in the longitudinal direction can be manufactured.

### Fourth Exemplary Embodiment

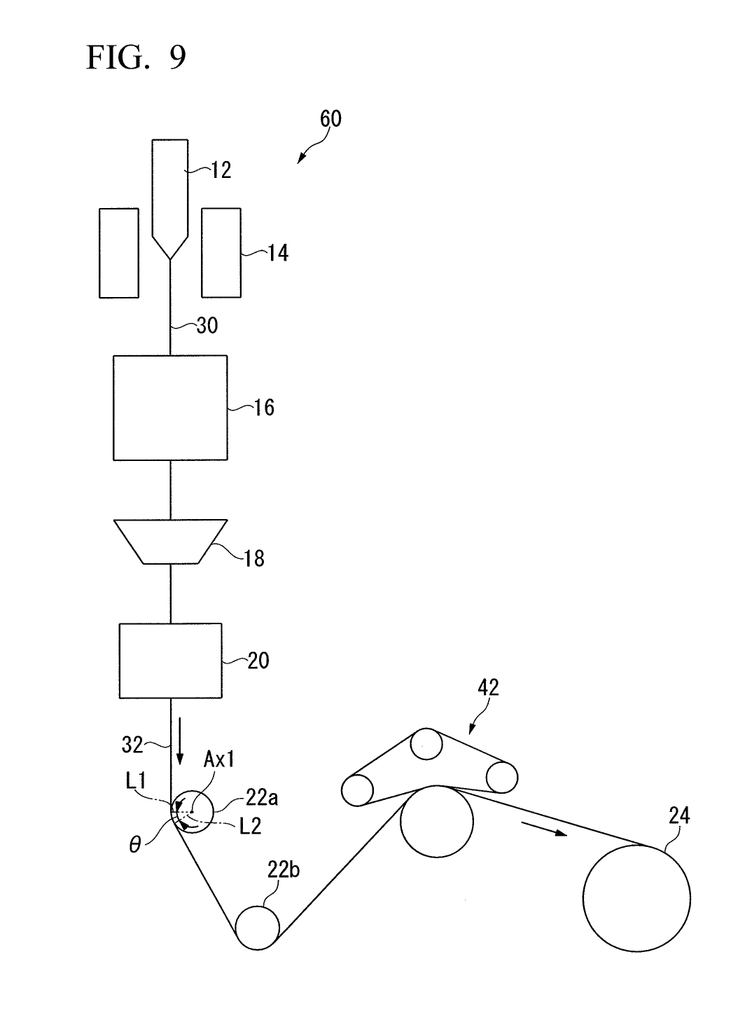

FIG. 9 is an explanatory view of an optical fiber manufacturing device 60 according to a fourth exemplary embodiment of the invention. Constituent elements of the optical fiber manufacturing device 60 shown in FIG. 9 which are identical to or correspondent with those of the optical fiber manufacturing device 10 shown in FIG. 1 are designated by identical reference numerals, and are not repetitiously explained.

In the optical fiber manufacturing device 60, two pulleys, namely a first pulley 22a and a second pulley 22b, are provided between the resin-curing unit 20 and the capstan 42. The first pulley 22a and the second pulley 22b rotate in the same direction.

In the optical fiber manufacturing device 60, the first pulley 22a first changes the traveling direction of an optical fiber 32 outputted from the resin-curing unit 20 in a direction, toward the bottom right as shown in FIG. 9, the second pulley 22b changes the traveling direction of the optical fiber 32 again in a direction, toward the top right as shown in FIG. 9; thereafter, the optical fiber 32 passes through the capstan 42 and is wound in the winder 24. The structure of the first pulley 22a is the same as that shown in FIG. 2. Also, the position of the axis of rotation of the second pulley 22b, which contacts the optical fiber 32 subsequent to the first pulley 22a, is fixed.

In the optical fiber manufacturing device 60, by setting the contact angle θ between the optical fiber 32 and the first pulley 22a, which is the first solid body that changes the traveling direction of the optical fiber 32 outputted from the resin-curing unit 20, in the range of 10° to 80°, a high-quality optical fiber 32 with reduced thickness variation can be manufactured, even at a high drawing speed of 1500 m/min or more.

Depending on the environment where the optical fiber manufacturing device 60 is installed, it may be necessary to bend the traveling direction of the optical fiber 32 to 90° or more from its traveling direction when it was outputted from the resin-curing unit 20. In this embodiment, a pulley with which the optical fiber 32 first makes contact does not bend the traveling direction to 90° or more from its traveling direction; instead, at the first pulley 22a that first contacts the optical fiber 32, the contact angle θ is set in the range of 10° to 80°, and the total traveling direction is bent to 90° or more by one or more pulleys that subsequently contact the optical fiber 32. This can reduce the thickness variation of the optical fiber 32, and increase the freedom for arranging the individual constituent elements in the optical fiber manufacturing device 60.

As in the optical fiber manufacturing device 10 described above, the optical fiber manufacturing device 60 can avoid problems such as a decrease in strength, poor external appearance of the optical fiber 32, and increased loss due to microbending. Furthermore, since there is no need for a tilting mechanism, a moving mechanism, or the like, the configuration of the optical fiber manufacturing device 60 can be simplified.

Also in this embodiment, the contact face of the first pulley 22a with the optical fiber 32 is formed such that it does not restrict the position of the optical fiber 32 in the width direction of the outer peripheral face of the first pulley 22a. Therefore, one-directional twisting of the optical fiber 32 and increased eccentricity are less likely to occur.

Also in this embodiment, the second pulley 22b, which is the solid body that contacts the optical fiber 32 subsequent to the first pulley 22a, is a rotating body, and the position of the axis of rotation of the second pulley 22b is fixed. Therefore, even if the contact face of the first pulley 22a with the optical fiber 32 is formed such that it does not restrict the position of the optical fiber 32 in the width direction of the outer peripheral face of the first pulley 22a, wobbling of the optical fiber 32 is suppressed and its path-line is stabilized. As a result, an optical fiber 32 having low eccentricity and low fluctuation of eccentricity in the longitudinal direction can be manufactured.

### Fifth Exemplary Embodiment

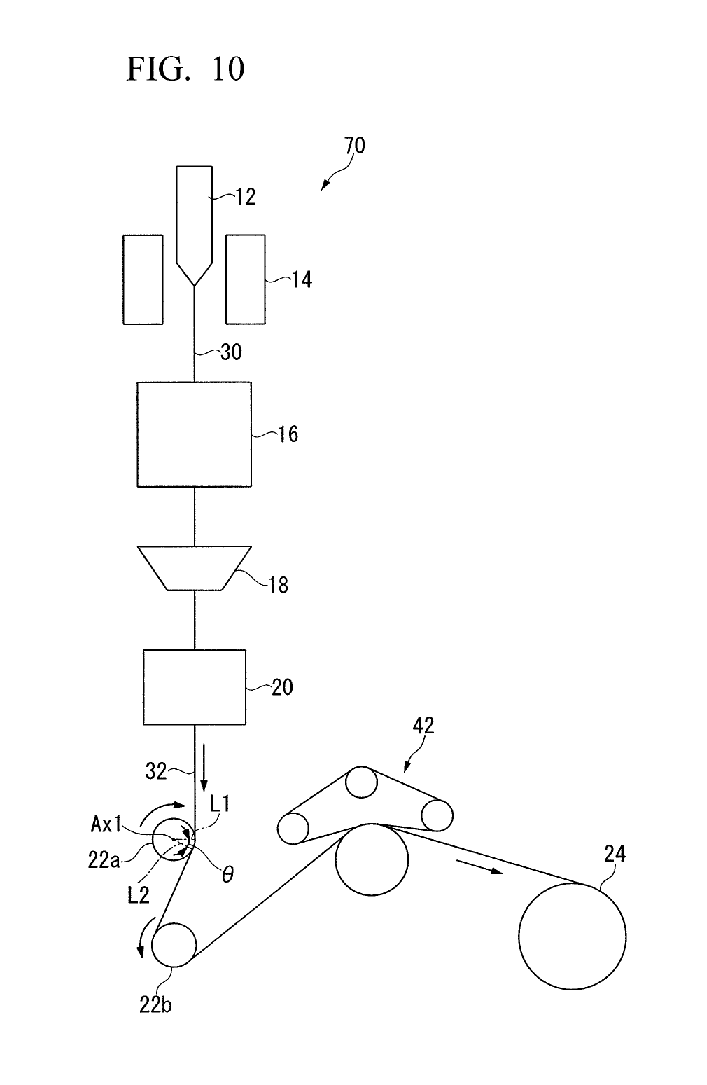

FIG. 10 is an explanatory view of an optical fiber manufacturing device 70 according to a fifth exemplary embodiment of the invention. Constituent elements of the optical fiber manufacturing device 70 shown in FIG. 10 which are identical to or correspondent with those of the optical fiber manufacturing device 10 shown in FIG. 1 are designated by identical reference numerals, and are not repetitiously explained.

In the optical fiber manufacturing device 70, as in the optical fiber manufacturing device 60 shown in FIG. 9, two pulleys, namely a first pulley 22a and a second pulley 22b, are provided between the resin-curing unit 20 and the capstan 42. In the optical fiber manufacturing device 70, the first pulley 22a and the second pulley 22b rotate in opposite directions.

In the optical fiber manufacturing device 70, the first pulley 22a first changes the traveling direction of an optical fiber 32 outputted from the resin-curing unit 20, the second pulley 22b changes the traveling direction of the optical fiber 32 again, and the optical fiber 32 then passes through the capstan 42 and is wound in a winder 24. The structure of the first pulley 22a is the same as that shown in FIG. 2. Also, the position of the axis of rotation of the second pulley 22b which contacts the optical fiber 32 subsequent to the first pulley 22a is fixed.

In the optical fiber manufacturing device 70, by setting the contact angle θ between the optical fiber 32 and the first pulley 22a, which is the solid body that first changes the traveling direction of the optical fiber 32 outputted from the resin-curing unit 20, in the range of 10° to 80°, it is possible to manufacture a high-quality optical fiber 32 with reduced thickness variation, even at high drawing speeds of 1500 m/min or more.

Moreover, in the optical fiber manufacturing device 70, since the first pulley 22a and the second pulley 22b rotate in mutually opposite directions as the optical fiber 32 passes them, the centrifugal forces acting on the optical fiber 32 work in mutually opposite directions. Since the forces acting on the optical fiber 32 thus cancel each other, the path-line of the optical fiber 32 becomes less likely to fluctuate, and the optical fiber 32 can be manufactured with low thickness variation. Furthermore, as in the optical fiber manufacturing device 60 shown in FIG. 9, it is possible to increase the freedom for arranging the individual constituent elements in the optical fiber manufacturing device 70.

In the optical fiber manufacturing device 70, as in the optical fiber manufacturing device 10 described above, problems such as a decrease in strength, poor external appearance of the optical fiber 32, and increased loss due to microbending can be avoided. Further, since there is no need for a tilting mechanism, a moving mechanism, or such like, the configuration of the optical fiber manufacturing device 70 can be simplified.

Also in this embodiment, the contact face of the first pulley 22a with the optical fiber 32 is formed such that it does not restrict the position of the optical fiber 32 in the width direction of the outer peripheral face of the first pulley 22a. Therefore, one-directional twisting of the optical fiber 32 and increased eccentricity are less likely to occur.

Also in this embodiment, the second pulley 22b, which is the solid body that contacts the optical fiber 32 subsequent to the first pulley 22a, is a rotating body, and the position of the axis of rotation of the second pulley 22b is fixed. Therefore, even if the contact face of the first pulley 22a with the optical fiber 32 is formed such that it does not restrict the position of the optical fiber 32 in the width direction of the outer peripheral face of the first pulley 22a, wobbling of the optical fiber 32 is suppressed and its path-line is stabilized. As a result, an optical fiber 32 having low eccentricity and low fluctuation of eccentricity in the longitudinal direction can be manufactured.

### Examples

Subsequently, examples of the invention will be explained along with comparative examples.

### Example 1

An optical fiber preform was heat-melted to form a bare optical fiber, and the bare optical fiber was extracted and cooled to an appropriate temperature. The bare optical fiber was coated with UV-curable primary resin, and passed through a UV radiation cross-linked tube to cure the primary resin. A secondary UV-curable resin was then applied, and this was cured by passing it through the UV radiation cross-linked tube (wet-on-dry coating process), obtaining an optical fiber. The optical fiber was first made to contact with a capstan, bending the traveling direction of the optical fiber, which was then wound in a winder. The contact angle θ of the optical fiber with the capstan at this time was 80°. The drawing speed was 1500 m/min. The installation position of the coating unit was set according to an ideal path-line of the optical fiber. Further, the coating unit was installed so as not to tilt. Microscopic examination of the thickness variation and external appearance of a test optical fiber revealed that the thickness variation along the longitudinal direction of the optical fiber was no greater than 1.1, and the condition of the interface was good.

### Example 2

An optical fiber preform was heat-melted to form a bare optical fiber, and the bare optical fiber was extracted and cooled to an appropriate temperature. The bare optical fiber was coated with UV-curable primary resin, and passed through a UV radiation cross-linked tube to cure the primary resin. A secondary UV-curable resin was then applied, and this was cured by passing it through the UV radiation cross-linked tube (wet-on-dry coating process), obtaining an optical fiber. The optical fiber was first made to contact with a pulley, bending the traveling direction of the optical fiber, which was then passed through a capstan and wound in a winder. The contact angle θ of the optical fiber with the pulley at this time was 10°, whereas the contact angle θ of the optical fiber with the capstan was 110°. The drawing speed was 1800 m/min. The installation position of the coating unit was set according to an ideal path-line of the optical fiber. The coating unit was installed so as not to tilt. Microscopic examination of the thickness variation and external appearance of a test optical fiber revealed that the thickness variation along the longitudinal direction of the optical fiber was no greater than 1.1, and the condition of the interface was good.

### Example 3

An optical fiber preform was heat-melted to form a bare optical fiber, and the bare optical fiber was extracted and cooled to an appropriate temperature. The bare optical fiber was coated with UV-curable primary resin and UV-curable secondary resin in one process, and passed through a UV radiation cross-linked tube to cure the primary and secondary resins together (wet-on-wet coating process), obtaining an optical fiber. Then, the optical fiber was first made to contact with a pulley, bending the traveling direction of the optical fiber, which was then passed through the capstan and wound in the winder. The contact angle θ of the optical fiber with the pulley at this time was 30°, and the contact angle θ of the optical fiber with the capstan was 90°. The drawing speed was 2200 m/min. The installation position of the coating unit was set according to an ideal path-line of the optical fiber. The coating unit was installed so as not to tilt. Microscopic examination of the thickness variation and external appearance of a test optical fiber revealed that the thickness variation along the longitudinal direction of the optical fiber was no greater than 1.1, and that the condition of the interface was good.

### Example 4

An optical fiber preform was heat-melted to form a bare optical fiber, and the bare optical fiber was extracted and cooled to an appropriate temperature. The bare optical fiber was coated with UV-curable primary resin and UV-curable secondary resin in one process, and passed through a UV radiation cross-linked tube to cure the primary and secondary resins together (wet-on-wet coating process), obtaining an optical fiber. The optical fiber was first made to contact with a pulley, the traveling direction of the optical fiber was bent, and the path-line was then bent again in the same direction at another pulley; the optical fiber was then passed through the capstan and wound in the winder. The contact angle θ of the optical fiber with the first pulley was 45°, the contact angle θ with the second pulley was also 45°, and the contact angle θ of the optical fiber with the capstan was 60°. The drawing speed was 2200 m/min. The installation position of the coating unit was set according to an ideal path-line of the optical fiber. The coating unit was installed so as not to tilt. Microscopic examination of the thickness variation and external appearance of a test optical fiber revealed that the thickness variation along the longitudinal direction of the optical fiber was no greater than 1.1, and the condition of the interface was good.

### Example 5

An optical fiber preform was heat-melted to form a bare optical fiber, and the bare optical fiber was extracted and cooled to an appropriate temperature. The bare optical fiber was coated with UV-curable primary resin and UV-curable secondary resin in one process, and passed through a UV radiation cross-linked tube to cure the primary and secondary resins together (wet-on-wet coating process), obtaining an optical fiber. The optical fiber was first made to contact with a pulley, the traveling direction of the optical fiber was bent, and the path-line was then bent again in the opposite direction at another pulley; the optical fiber was then passed through the capstan and wound in the winder. The contact angle θ of the optical fiber with the first pulley was 60°, the contact angle θ with the second pulley was also 60°, and the contact angle θ of the fiber with the capstan was 120°. The drawing speed was 2800 m/min. The installation position of the coating unit was set according to an ideal path-line of the optical fiber. The coating unit was installed so as not to tilt. Microscopic examination of the thickness variation and external appearance of a test optical fiber revealed that the thickness variation along the longitudinal direction of the optical fiber was no greater than 1.1, and the condition of the interface was good.

### Comparative Example 1

An optical fiber preform was heat-melted to form a bare optical fiber, and the bare optical fiber was extracted and cooled to an appropriate temperature. The bare optical fiber was coated with UV-curable primary resin, and passed through a UV radiation cross-linked tube to cure the primary resin. Secondary UV-curable resin was then applied, and this was cured by passing it through the UV radiation cross-linked tube (wet-on-dry coating process), obtaining an optical fiber. The optical fiber was first made to contact with a capstan, bending the traveling direction of the optical fiber, which was then wound in a winder. The contact angle θ of the optical fiber with the capstan was 90°. The drawing speed was 1500 m/min. The installation position of the coating unit was set according to an ideal path-line of the optical fiber. Further, the coating unit was installed so as not to tilt. Microscopic examination of the thickness variation and external appearance of a test optical fiber revealed that the thickness variation along the longitudinal direction of the optical fiber was equal to or greater than 1.5, and the condition of the interface was undulating, hence poor.

### Comparative Example 2

An optical fiber preform was heat-melted to faun a bare optical fiber, and the bare optical fiber was extracted and cooled to an appropriate temperature. The bare optical fiber was coated with UV-curable primary resin and UV-curable secondary resin in one process, and passed through a UV radiation cross-linked tube to cure the primary and secondary resins together (wet-on-wet coating process), obtaining an optical fiber. The optical fiber was first made to contact with a pulley, bending the traveling direction of the optical fiber, which was then passed through the capstan and wound in a winder. The contact angle θ of the optical fiber with the pulley was 5°, and the contact angle θ of the fiber with the capstan was 120°. The drawing speed was 2800 m/min. The installation position of the coating unit was set according to an ideal path-line of the optical fiber. Further, the coating unit was installed so as not to tilt. Microscopic examination of the thickness variation and external appearance of a test optical fiber revealed that the thickness variation along the longitudinal direction of the optical fiber was equal to or greater than 1.5, and the condition of the interface was undulating, hence poor.

In these examples, not only was the thickness variation reduced, but also the stability of the interface of the optical fiber was increased. In JP 2003-252653, mentioned above, when the coating unit is tilted too much with respect to the bare optical fiber, there is a possibility that the bare optical fiber will contact with some of the components of the coating unit, reducing the stability of the interface. According to exemplary embodiments of this invention, even if the drawing speed is high at 1500 m/min or more, it is possible to manufacture a high-quality optical fiber with reduced thickness variation and a stable interface.

As mentioned above, the invention has been described with reference to exemplary embodiments thereof However, the invention is not limited to the embodiments, and it will be understood by those of ordinary skill in the art that various changes in combination of component elements or process thereof can be made as modified examples, and that those modified examples are also within the scope of the invention.

While in the embodiments, pulleys and a capstan are used as solid bodies for changing the traveling direction of the optical fiber, any member that can change the traveling direction of the optical fiber is usable, there being no particular restriction on the solid body. For example, a capstan, a roller guide, or such like may be used as a solid body that changes the traveling direction of the optical fiber.

While in the embodiments, the traveling direction of the optical fiber is changed by providing a solid body such as a pulley or a capstan immediately after the resin-curing unit, a solid body that does not change the traveling direction of the optical fiber, such as a mechanism that merely twists the optical fiber, may be provided between the resin-curing unit and the solid body that changes the traveling direction.

According to an optical fiber manufacturing device of an exemplary embodiment of this invention, an optical fiber traveling between a coating unit and a rotating body can be made to follow a desired path-line. Thus, even if the drawing speed is high at 1500 m/min or more, the path-line of a bare optical fiber as it passes the coating unit can be prevented from greatly fluctuating with respect to the coating unit, thereby suppressing eccentricity of a coating layer with respect to the bare optical fiber. Therefore, a high-quality optical fiber can be manufactured at a high drawing speed and with a simple configuration.

1-11. (canceled)

12. An optical fiber manufacturing device comprising:
a bare optical fiber-forming unit that forms a bare optical fiber by pulling an optical fiber preform;
a coating unit that forms an optical fiber by coating the bare optical fiber outputted from the bare optical fiber-forming unit with a coating layer;
a first direction-converter, that contacts the optical fiber outputted from the coating unit and changes a traveling direction of the optical fiber; and
a winder that winds the optical fiber obtained from the first direction-converter, wherein:
the first direction-converter comprises a rotating body having an axis of rotation and a circumferential face, around the axis of rotation, that contacts with the optical fiber; and
a contact angle, centered on the axis of rotation, between the rotating body and the optical fiber is in the range of about 10° to 80°.

13. The optical fiber manufacturing device according to claim 12, wherein the circumferential face, when viewed in cross-section, is substantially flat.

14. The optical fiber manufacturing device according to claim 12, further, between the first direction-converter and the winder, a second direction-converter which changes a traveling direction of the optical fiber and comprises a rotating body.

15. The optical fiber manufacturing device according to claim 14, wherein a position of an axis of rotation of the rotating body of the second direction-converter is fixed.

16. The optical fiber manufacturing device according to claim 15, wherein the rotating body of the first direction-converter and the rotating body of the second direction-converter rotate in mutually opposite directions.

17. An optical fiber manufacturing method comprising:
forming a bare optical fiber by pulling an optical fiber preform;
forming an optical fiber by coating the bare optical fiber;
changing a traveling direction of the optical fiber by contacting the optical fiber with a circumferential face of a rotating body; and
winding the optical fiber,
wherein a contact angle, centered on an axis of rotation of the rotating body, between the rotating body and the optical fiber is in the range of about 10° to 80°.

18. The optical fiber manufacturing method according to claim 17, wherein, when contacting the optical fiber with the circumferential face of the rotating body, the optical fiber is allowed to move freely, an a direction of the axis of rotation, on the circumferential face.

19. The optical fiber manufacturing method according to claim 17, wherein the rotating body is a first rotating body, and the method further comprises, between changing the traveling direction of the optical fiber and winding the optical fiber:
further changing the traveling direction of the optical fiber by contacting the optical fiber with a second rotating body, which is disposed downstream from the first rotating body.

20. The optical fiber manufacturing method according to claim 19, wherein a position of an axis of rotation of the second rotating body is fixed.

21. The optical fiber manufacturing method according to claim 19, wherein the first rotating body and the second rotating body rotate in mutually opposite directions.

22. The optical fiber manufacturing method according to claim 17, wherein the drawing speed of the bare optical fiber is no less than about 1500 m/min.

23. An optical fiber manufacturing device comprising:
an optical fiber forming apparatus into which an optical fiber preform is passed, and which outputs a coated optical fiber.
a first direction-converter, comprising a rotating body comprising a circumferential face having an axis of rotation, positioned such that the circumferential face contacts the optical fiber over a rotation angle, wherein the rotation angle is between about 10° and 80 °.

24. The optical fiber manufacturing device according to claim 23, wherein the first direction-converter comprises a pulley, and the manufacturing device further comprises:
a capstan, which contacts the optical fiber, positioned downstream, in an optical fiber passing direction, from the pulley;
wherein a rotating direction of a rotating body of the capstan is opposite to a rotating direction of the pulley.
